(19) United States
(12) Patent Application Publication
(10) Pub. No.: US 2016/0301439 A1
(43) Pub. Date: Oct. 13, 2016

(54) COMBINED COMMUNICATIONS-TRANSPONDER AVIONICS RADIO UNIT

(71) Applicant: Honeywell International Inc., Morristown, NJ (US)

(72) Inventor: Christian Dale Brinkley, Plymouth, MN (US)

(21) Appl. No.: 14/317,727

(22) Filed: Jun. 27, 2014

(51) Int. Cl. H04B 1/3822; H04B 1/40

(52) U.S. Cl. CPC H04B 1/3822; H04B 1/40

(57) ABSTRACT

Combined communications-transponder avionics radio units are provided. In one embodiment, a communications-transponder avionics radio unit is provided. The unit comprises: a first component bay having a communications (COMM) radio unit; a second component bay having a transponder unit; a control display unit divided into a first control display interface area for a COMM radio control display in communication with the COMM radio unit, and a second control display interface area for a transponder radio control display in communication with the Transponder Unit; and an enclosure housing the first component bay, the second component bay and the control display unit.

### BACKGROUND

Over time, the airspace in the United States has become more structured. Where once travel by private aircraft required no real need for aviation electronics (“avionics”), today's busy airspace demands more integration between ground controllers and aircraft. Current airspace around major airports often limits entry to those aircraft that can both communicate with air traffic control via a communications (COMM) radio and report their position to Air Traffic Control via a radar transponder. For example, a COMM radio is needed to communicate with Air Traffic Control (ATC) in order to enter Class B air space since all aircraft entering Class B airspace must obtain ATC clearance prior to entry. Similarly, aircraft entering a Mode C veil need to have an altitude reporting Mode C transponder in operation to enter that airspace.

For the reasons stated above and for other reasons stated below which will become apparent to those skilled in the art upon reading and understanding the specification, there is a need in the art for improved systems and methods for a combined COMM-transponder avionics radio unit.

### SUMMARY

The Embodiments of the present invention provide methods and systems for a combined COMM-transponder avionics radio unit and will be understood by reading and studying the following specification.

Combined communications-transponder avionics radio units are provided. In one embodiment, a communications-transponder avionics radio unit is provided. The unit comprises: a first component bay having a communications (COMM) radio unit; a second component bay having a transponder unit; a control display unit divided into a first control display interface area for a COMM radio control display in communication with the COMM radio unit, and a second control display interface area for a transponder radio control display in communication with the Transponder Unit; and an enclosure housing the first component bay, the second component bay and the control display unit.

### DRAWINGS

Embodiments of the present invention can be more easily understood and further advantages and uses thereof more readily apparent, when considered in view of the description of the preferred embodiments and the following figures in which:

FIG. 1 is a block diagram of a COMM-transponder avionics radio unit of one embodiment of the present disclosure;

FIG. 2 illustrates an example control display unit for a COMM-transponder avionics radio unit of one embodiment of the present disclosure; and

FIG. 3 illustrates another example control display unit for a COMM-transponder avionics radio unit of one embodiment of the present disclosure.

In accordance with common practice, the various described features are not drawn to scale but are drawn to emphasize features relevant to the present invention. Reference characters denote like elements throughout figures and text.

### DETAILED DESCRIPTION

In the following detailed description, reference is made to the accompanying drawings that form a part hereof, and in which is shown by way of specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the scope of the present invention. The following detailed description is, therefore, not to be taken in a limiting sense.

Embodiments of the present invention provide a single radio package which can be installed inside the limited space available on a small aircraft, but provides the pilot with all the functionality needed to traverse all the airspace in the United States with a single piece of avionics. Embodiments of the present disclosure describe solutions to the above described problem by combining the COMM transceiver functionality with the Transponder functionality in such a way that they do not interfere with each other during operation. For example, this may be accomplished by packaging each radio section in a grounded enclosure while still maintaining their ability to be packaged in such a manner as to fit into a general aviation aircraft individually. The COMM radio section may be constructed either for the standard 118-136 MHz frequency range, or an extended 108-136 MHz frequency range which will include the Navigation (Nav) frequencies. Including extended Nav frequencies will allow the pilot to listen to information (such as weather and Flight Service) being broadcast over the Very High Frequency (VHF) Omnidirectional Range (VOR) transmitter system. Combining the COMM and transponder radio functions in the manner described herein give provides a combination COMM plus Transponder unit that takes up less panel space than the traditional implementations, is less expensive, and is easier for the pilot to use.

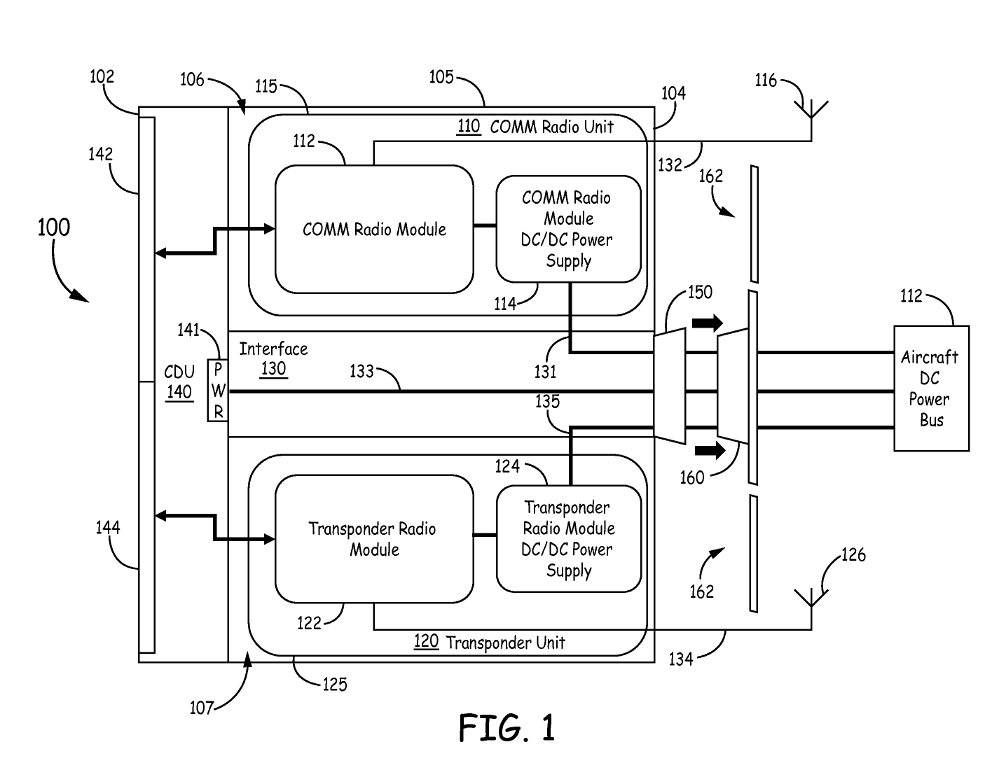

FIG. 1 is a block diagram illustrating a COMM-transponder avionics radio unit 100 of one embodiment of the present invention. COMM-transponder avionics radio unit 100 comprises an enclosure 105 having a first component bay 106 that houses a COMM Radio Unit 110, and a second component bay 107 that houses a Transponder Unit 120. The front side 102 of the COMM-transponder avionics radio unit 100 includes a control display unit 140 divided into a first control display interface area having a COMM Radio Control Display 142 in communication with the COMM Radio Unit 110, and a second control display interface area having a Transponder Radio Control Display 144 in communication with the Transponder Unit 120. The back side 104 of the COMM-transponder avionics radio unit 100 includes at least one electrical coupling device 150 (such as a self-aligning or blind-mate connector). When the COMM-transponder avionics radio unit 100 is installed by inserting it backside 104 first into a radio rack, the electrical coupling device 150 is aligned to and mates with a corresponding electrical coupling device 160 secured to a chassis 162 of the aircraft.

Enclosure 105 further includes an interface component 130 (which may comprise an electronics board, for example) which in some embodiments incorporates the electrical coupling device 150 and provides electrical connectivity between the COMM Radio Unit 110, the Transponder Unit 120, and the control display unit 140, and the at least one electrical coupling device 150. In some embodiments, interface component 130 also forms a physical barrier that separates the first component bay 106 from the second component bay 107. For example, for some implementations, the COMM Radio Unit 110 within the first component bay 106 and the Transponder Unit 120 within the second component bay 107 are each no more than 3 inches wide and no more than 1.3 inches tall, allowing the two units 110, 120 plus the interface component 130 to be placed side by side and fit within a standard 6.25″ wide radio rack. In one embodiment, COMM-transponder avionics radio unit 100 is implemented with a form factor of a dual sided line replaceable unit (LRU).

In the embodiment shown in FIG. 1, COMM Unit 110 includes a COMM radio module 112 and a DC/DC power supply 114. DC/DC Power Supply 114 is coupled to the Aircraft's DC power Bus 112 by a conductive path 131 provided by interface component 130 and through the mated electrical coupling device 150 and 160. DC/DC power supply 114 is also coupled to the COMM radio module 112, providing it with the electrical power needed to perform its COMM radio functionality. As mentioned above, COMM radio module 112 can be configured as a radio transceiver that operators in either a standard 118-136 MHz frequency range, an extended 108-136 MHz frequency range, or some other range that carries channels for pilot use, such as ATC communications. In some implementations, COMM radio module 112 also supports tuning to Nav frequencies to allow the pilot to listen to information (such as weather and Flight Service) being broadcast over the VOR transmitter system. In order to transmit to and receive communications from ATC ground stations, COMM radio module 112 is coupled to an aircraft mounted antenna 116 tuned for use with COMM radio module's frequency range. COMM radio module 112 is coupled to the aircraft mounted antenna 116 by a conductive path 132.

Transponder Unit 120 includes a Transponder Radio Module 122 and a DC/DC power supply 124. DC/DC Power Supply 124 is coupled to the Aircraft's DC power Bus 112 by a conductive path 135 provided by interface component 130 and through the mated electrical coupling device 150 and 160. DC/DC power supply 124 is also coupled to the Transponder radio module 122, providing it with the electrical power needed to perform its Transponder functionality. For example, in one embodiment, the transponder radio module 122 may respond to ATC interrogations from a ground station by transmitting radio frequency signals that send back information such as the aircraft's identification code, and/or altitude information. Providing separate power supplies 114 and 124 for each of the respective radio units 110, 120 eliminates a single point failure mechanism that could otherwise result in the simultaneous loss of both transponder and COMM functionality. That is, failure of a single power supply within COMM-transponder avionics radio unit 100 will not result in the loss of both the transponder and COMM functions. In order to receive interrogations and transmit responses, transponder radio module 122 is coupled to an aircraft mounted antenna 126 tuned for use with the transponder radio module's frequency range. More specifically, transponder radio module 122 is coupled to the aircraft mounted antenna 126 by a conductive path 134. In still other embodiments, interface component 130 may also include additional path for data, control, or power. For example, interface component 130 may provide one or more data buses for providing data in to or out from modules 112 and 122 via electrical coupling device 150, or similarly a dimmer control signal for controlling the brightness of the control display unit 140.

In one embodiment, COMM-transponder avionics radio unit 100 may include a Ferriday cage around the COMM radio unit 110 (shown at 115), around the Transponder unit 120 (shown at 125), or both, in order to shield components within unit 110 from induced Radio Frequency (RF) noise.

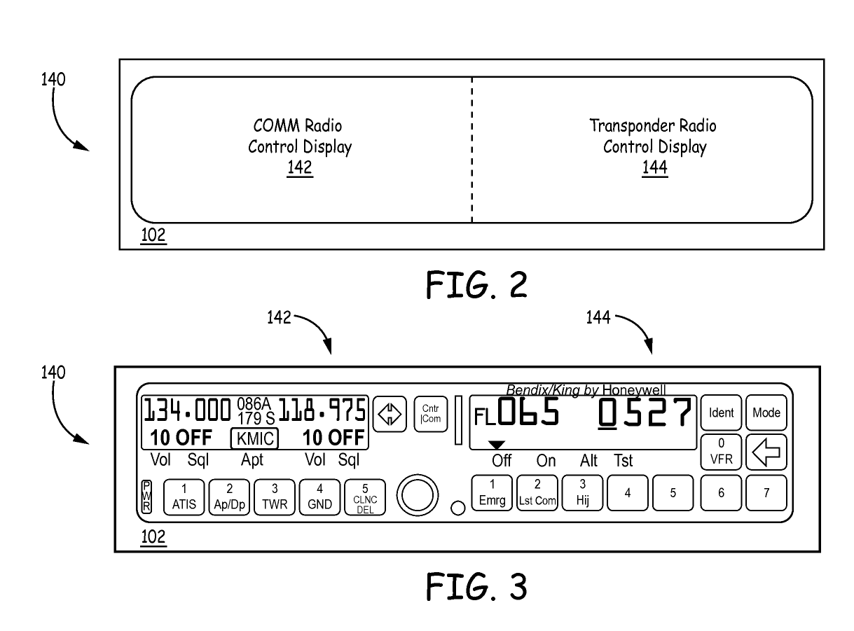

As illustrated by FIG. 2, the control display unit 140 provides a common control and display interface that is mounted across the front 102 of the COMM-transponder avionics radio unit 100 and provides the operator with a means to control both the COMM radio unit 110 and the Transponder Unit 120, and receive feedback from those components. In one embodiment the control display unit 140 includes a power interface 141 which is also coupled to the Aircraft's DC power Bus 112 by a conductive path 133 provided by interface component 130 and through the mated electrical coupling device 150 and 160. It should be noted that although Interface 130 is shown as providing power from the aircraft's DC power bus 112 via three separate conductive paths 131, 133 and 135, in other embodiments, power may be provided to the components of COMM-transponder avionics radio unit 100 via a single DC power bus within interface 130 that is coupled to the DC power bus 112 through the mated electrical coupling device 150 and 160. The COMM Radio Control Display 142 is generated by the COMM Radio Module 112 and provides an interface where the pilot may adjust various radio setting. The COMM Radio Control Display 142 may also include one or more I/O jacks for plugging in a pilot headset having a speaker and microphone to facilitate voice communications. The Transponder Radio Control Display 144 is generated by the transponder radio module 122 and provides an interface where the pilot may adjust various transponder settings.

FIG. 3 illustrates one implementation of a control display unit 140 providing both a COMM Radio Control Display 142 and a Transponder Radio Control Display 144. It should be noted that although FIGS. 1-3 have illustrated the components associated with the COMM radio on the left side of the COMM-transponder avionics radio unit 100, and components associated with the transponder on the right side of the COMM-transponder avionics radio unit 100, this arrangement is for illustrative purposes only and the position of the components may be different for other implementations.

### EXAMPLE EMBODIMENTS

Example 1 includes a communications-transponder avionics radio unit, the unit comprising: a first component bay having a communications (COMM) radio unit; a second component bay having a transponder unit; a control display unit divided into a first control display interface area for a COMM radio control display in communication with the COMM radio unit, and a second control display interface area for a transponder radio control display in communication with the Transponder Unit; and an enclosure housing the first component bay, the second component bay and the control display unit.

Example 2 includes the unit of example 1, further comprising: an interface component comprising at least one electrical coupling device configured to mate with an electrical coupling device external to the enclosure; wherein the interface component provides within the enclosure electrical connectivity between the COMM radio unit, the transponder unit, the control display unit, and the at least one electrical coupling device.

Example 3 includes the unit of example 2, wherein the interface component forms a physical barrier that separates the first component bay from the second component bay.

Example 4 includes the unit of any of examples 2-3, wherein the COMM radio unit includes a COMM radio module configured to couple to an aircraft mounted antenna.

Example 5 includes the unit of any of examples 2-4, the COMM radio unit further comprising: a DC/DC Power Supply coupled to a COMM radio module; wherein the DC/DC Power Supply is configured to couple to a DC power bus via the at least one electrical coupling device by a conductive path provided by the interface component.

Example 6 includes the unit of any of examples 2-5, wherein the transponder unit includes a transponder radio module configured to couple to an aircraft mounted antenna.

Example 7 includes the unit of any of examples 2-6, the transponder radio unit further comprising: a DC/DC power supply coupled to a transponder radio module; wherein the DC/DC power supply is configured to couple to a DC power bus via the at least one electrical coupling device by a conductive path provided by the interface component.

Example 8 includes the unit of any of examples 1-7, wherein the interface component include further comprises: one or more data bus paths; one of more control signal paths

Example 9 includes the unit of any of examples 1-8, wherein the enclosure further includes one or both of: a first Ferriday cage around the COMM radio unit; and a second Ferriday cage around the transponder radio unit.

Example 10 includes the unit of any of examples 1-9, wherein the control display unit provides a common control and display interface mounted across a front of the unit.

Example 11 includes the unit of example 10, wherein the control display unit includes a power interface coupled to a DC power bus via the at least one electrical coupling device by a conductive path provided by the interface component.

Example 12 includes the unit of any of examples 1-11, wherein the COMM radio control display is generated by the COMM radio unit; and the transponder radio control display is generated by the transponder radio unit and provides an interface where the pilot may adjust various transponder settings.

Example 13 includes the unit of any of examples 1-12, wherein the enclosure is implemented with a form factor conforming to a dual sided line replaceable unit (LRU).

Example 14 includes the unit of any of examples 1-13, wherein the enclosure is installed into a radio rack of an aircraft.

Example 15 includes the unit of example 14, wherein the enclosure is configured to mount within a 6.25″ wide radio rack.

Example 16 includes a communications-transponder avionics radio unit, the unit comprising: an enclosure comprising a communications (COMM) radio unit, a transponder unit, at least one electrical coupling device on a back side of the enclosure, and a control display unit on a front side of the enclosure; wherein the control display comprises a first control display interface area associated with the communications radio unit, and a second display area control display interface area associated with the transponder unit; and wherein the at least one electrical coupling device is configured to distribute power to the COMM radio unit, a transponder unit, at least one electrical coupling device.

Example 17 includes the unit of example 16 further comprising: an interface component internal to the enclosure, wherein the communications radio unit, the transponder unit, and the control display unit are each coupled to the at least one electrical coupling device by the interface component.

Example 18 includes the unit of any of examples 16-17, the communications radio unit further comprising: a first DC/DC power supply internal to the enclosure, where the first DC/DC power supply provides power to a COMM radio module and is provided power from the at least one electrical coupling device.

Example 19 includes the unit of example 18, the transponder radio unit further comprising: a second DC/DC power supply internal to the enclosure, where the second DC/DC power supply provides power to a transponder radio module and is provided power from the at least one electrical coupling device.

Example 20 includes the unit of any of examples 16-19, wherein the enclosure is configure to install into a standard a standard 6.25″ wide avionics radio rack.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

1. A communications-transponder avionics radio unit, the unit comprising:
a first component bay having a communications (COMM) radio unit;
a second component bay having a transponder unit;
a control display unit divided into a first control display interface area for a COMM radio control display in communication with the COMM radio unit, and a second control display interface area for a transponder radio control display in communication with the Transponder Unit; and
an enclosure housing the first component bay, the second component bay and the control display unit.

2. The unit of claim 1, further comprising:
an interface component comprising at least one electrical coupling device configured to mate with an electrical coupling device external to the enclosure;
wherein the interface component provides within the enclosure electrical connectivity between the COMM radio unit, the transponder unit, the control display unit, and the at least one electrical coupling device.

3. The unit of claim 2, wherein the interface component forms a physical barrier that separates the first component bay from the second component bay.

4. The unit of claim 2, wherein the COMM radio unit includes a COMM radio module configured to couple to an aircraft mounted antenna.

5. The unit of claim 2, the COMM radio unit further comprising:
a DC/DC Power Supply coupled to a COMM radio module;
wherein the DC/DC Power Supply is configured to couple to a DC power bus via the at least one electrical coupling device by a conductive path provided by the interface component.

6. The unit of claim 2, wherein the transponder unit includes a transponder radio module configured to couple to an aircraft mounted antenna.

7. The unit of claim 2, the transponder radio unit further comprising:
a DC/DC power supply coupled to a transponder radio module;
wherein the DC/DC power supply is configured to couple to a DC power bus via the at least one electrical coupling device by a conductive path provided by the interface component.

8. The unit of claim 1, wherein the interface component include further comprises:
one or more data bus paths;
one or more control signal paths.

9. The unit of claim 1, wherein the enclosure further includes one or both of:
a first Ferriday cage around the COMM radio unit; and
a second Ferriday cage around the transponder radio unit.

10. The unit of claim 1, wherein the control display unit provides a common control and display interface mounted across a front of the unit.

11. The unit of claim 10, wherein the control display unit includes a power interface coupled to a DC power bus via the at least one electrical coupling device by a conductive path provided by the interface component.

12. The unit of claim 1, wherein the COMM radio control display is generated by the COMM radio unit; and
the transponder radio control display is generated by the transponder radio unit and provides an interface where the pilot may adjust various transponder settings.

13. The unit of claim 1, wherein the enclosure is implemented with a form factor conforming to a dual sided line replaceable unit (LRU).

14. The unit of claim 1, wherein the enclosure is installed into a radio rack of an aircraft.

15. The unit of claim 14, wherein the enclosure is configured to mount within a 6.25″ wide radio rack.

16. A communications-transponder avionics radio unit, the unit comprising:
an enclosure comprising a communications (COMM) radio unit, a transponder unit, at least one electrical coupling device on a back side of the enclosure, and a control display unit on a front side of the enclosure;
wherein the control display comprises a first control display interface area associated with the communications radio unit, and a second display area control display interface area associated with the transponder unit; and
wherein the at least one electrical coupling device is configured to distribute power to the COMM radio unit, a transponder unit, at least one electrical coupling device.

17. The unit of claim 16 further comprising:
an interface component internal to the enclosure, wherein the communications radio unit, the transponder unit, and the control display unit are each coupled to the at least one electrical coupling device by the interface component.

18. The unit of claim 16, the communications radio unit further comprising:
a first DC/DC power supply internal to the enclosure, where the first DC/DC power supply provides power to a COMM radio module and is provided power from the at least one electrical coupling device.

19. The unit of claim 18, the transponder radio unit further comprising:
a second DC/DC power supply internal to the enclosure, where the second DC/DC power supply provides power to a transponder radio module and is provided power from the at least one electrical coupling device.

20. The unit of claim 16, wherein the enclosure is configure to install into a standard a standard 6.25″ wide avionics radio rack.
